(19) United States
(12) Patent Application Publication
(10) Pub. No.: US 2015/0099533 A1
(43) Pub. Date: Apr. 9, 2015

(54) METHODS AND SYSTEMS FOR CORRECTING AND COMMUNICATING LOCATION INFORMATION IN A WIRELESS COMMUNICATION ENVIRONMENT

(71) Applicant: QATAR UNIVERSITY QSTP-B, Doha (QA)

(72) Inventors: Hamid Menouar, Doha (QA); Fethi Filali, Doha (QA); Adnan Abu-Dayya, Doha (QA)

(73) Assignee: Qatar University QSTP-B, Doha (QA)

(21) Appl. No.: 14/395,706

(22) PCT Filed: May 25, 2012
(86) PCT No.: PCT/IB2012/052650

§ 371 Date: Oct. 20, 2014

(30) Foreign Application Priority Data
May 25, 2012 (IB) PCTIB2012052560

(51) Int. Cl. H04W 64/00

(52) U.S. Cl. CPC H04W 64/003
USPC 455/456.1

(57) ABSTRACT

Disclosed are methods and systems for correcting and communicating location information of a node in a wireless communication network environment. The method comprises the steps of: calculating atleast a position offset, obtaining position coordinates of atleast a localizer, calculating atleast position coordinates of atleast a communicator, and communicating the position coordinates of the communicator as the location information of the node.

### FIELD OF THE INVENTION

The present invention relates generally to wireless communication systems, and more particularly, to methods and systems for correcting and communicating the location information of a node in wireless communication environment in a convenient, cost effective, secure, and environmental friendly manner.

### BACKGROUND OF THE INVENTION

Nowadays vehicles are equipped with a variety of informational systems such as navigation systems, satellite radio systems, Global Positioning Systems (also referred to as ‘GPS’), two-way satellite services, built-in cell phones, DVD players etc. These systems are sometimes interconnected for increased functionality.

Various informational systems have been developed that use wireless communications between vehicles, and between vehicles and infrastructures, such as roadside units. These wireless communications have a wide range of applications ranging from crash avoidance, vehicle tracking to entertainment systems, etc.

Wireless communication technology can be used to provide various information from vehicle-to/from-infrastructure, and from vehicle-to-vehicle, such as providing GPS location, vehicle speed and other vehicle Parameter Identifiers (PIDs) including engine speed, engine run time, engine coolant temperature, barometric pressure, etc. When communications are established with between vehicles and/or roadside units in close proximity, this information would be communicated to provide a complete understanding of the vehicles in the broadcast area. This information then can be used by the vehicles for both vehicle safety applications and non-safety applications.

There are several mobile wireless communication systems where geographical location is required. A GPS antenna is used to find the location of the vehicle and this location information is communicated to other vehicles and/or roadside units in close proximity.

In communication systems such as Vehicle-to-Vehicle and Vehicle-to/from-Infrastructure (V2X), each communicating node knows its geographical location. The geographical location information of a node (vehicles or roadside units) is used locally by processes, mechanisms, protocols, and applications running in that node, and also by the same running at other nodes in the surrounding vicinity. Some applications and system functionalities rely on this location information, which is assumed so far to be the same as the location information of the wireless communication antenna. This assumption is not valid anymore with emerging vehicular communication systems where the location information of the communicating node as given by the localization system (e.g. GPS) can be different from the one of the wireless communication antenna. In fact, for some systems it is important to consider the location of the wireless (communication) antenna rather than the location of the GPS antenna.

Systems where communication nodes are of a certain size which results in a difference between the location (installation position) of the communication point and the localization point. For example, in case of vehicular communication systems where nodes are vehicles, the localization point (e.g. GPS antenna) and the communication point (e.g. short range communication antenna) could be installed at different locations on the vehicle. This difference can be relatively high in case of large size vehicles, such as buses and trucks. As per the ETSI ITS standardization technical committee's (ETSI TC ITS) latest standard drafts, it is always the location of the GPS (GNSS) antenna or the vehicle front middle position which is used to indicate the vehicle's location. The vehicle front middle location is important at application layer as it is used for safety applications, but it does not ensure reliable and accurate routing functionalities at lower layers. If the wireless communication antenna is installed at the back of the vehicle and the vehicle position is referred as the front middle of the vehicle, then this will certainly lead to unaccepted inefficiency in most of the geographical-based routing functionalities.

Several methods attempted to solve the above mentioned problems. One method involves putting the localization point and the communication point at the same location on the communication node. For example, in case of V2X, this means that the localization point (e.g. GPS antenna) and the communication point (e.g. IEEE 802.11p, DSRC or WAVE communication antenna) must be installed at the same place on the vehicle. This basic solution solves the above mentioned problem, but it adds additional constraints for vehicle makers by forcing them to always install the two antennas at the same place. This reduced freedom is not welcomed by car designers.

Another method is to add additional information to the location information of a node to indicate the location of the communication point. This solution implicitly solves the above mentioned problem, but it results in additional data in the transmitted information which leads to more bandwidth consumption.

In a further method additional information indicative of the relative location (offset) of the communication point is added to the location information of a node. This method solves the problem, but it also additional data to be transmitted and results in more bandwidth consumption.

In view of the foregoing shortcomings inherent in the conventional vehicular communication systems, there exists a need for a system and method for correcting the location information of a vehicle in wireless communication.

### SUMMARY OF THE INVENTION

In view of the foregoing shortcomings inherent in the conventional vehicular communication systems, the general purpose of the present invention is to provide an improved combination of convenience and utility, to include the advantages of the prior art, and to overcome the drawbacks inherent therein.

In one aspect, the present invention provides a method for correcting and communicating location information of atleast a node in a wireless communication environment. The method comprises the steps of: calculating atleast a position offset, obtaining position coordinates of atleast a localizer, calculating atleast position coordinates of atleast a communicator, and communicating the position coordinates of the communicator as the location information of the The position offset/relative position is distance between the communicator and the localizer on the node.

In another aspect, the present invention provides a system for correcting and communicating location information of atleast the node in a wireless communication environment. The system comprises atleast a localizer capable of obtaining atleast position coordinates, atleast a communication unit capable of enabling the node to communicate with other communicating units, atleast the communicator capable of wirelessly transmitting/communicating atleast a data broadcasted by the communication unit, and atleast a Geo-localization unit capable of calculating atleast the position coordinates of the communicator.

In another aspect, the present invention proposes to indicate the location of the communicator as the location of the communicating node, regardless of the location of the localizer (e.g. GPS antenna). The present invention is capable of indicating the geographical location of the communication point rather than the geographical location of the localization point.

These together with other objects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the present invention.

### BRIEF DESCRIPTION OF THE DRAWINGS

While the specification concludes with claims that particularly point out and distinctly claim the invention, it is believed the expressly disclosed exemplary embodiments of the present invention can be understood from the following description taken in conjunction with the accompanying drawings, in which like reference numerals identify the same elements. The drawings and detailed description which follow are intended to be merely illustrative of the expressly disclosed exemplary embodiments and are not intended to limit the scope of the invention as set forth in the appended claims. In the drawings:

FIG. 1 illustrates a vehicle with a communicator and a localizer installed at same place on a vehicle, according to an exemplary embodiment of the present invention;

FIG. 2 illustrates a schematic diagram of vehicular communication when the communicator and the localizer are installed at same place on the vehicle, according to an exemplary embodiment of the present invention;

FIG. 3 illustrates a vehicle with communicator and the localizer are installed at different places on the vehicle, according to an exemplary embodiment of the present invention;

FIG. 4 illustrates a schematic diagram of vehicular communication when the communicator and the localizer are installed at different places on one of the vehicle, according to an exemplary embodiment of the present invention;

FIG. 5 illustrates a schematic diagram of vehicular communication, according to an exemplary embodiment of the present invention;

FIG. 6 illustrates a flowchart of a method for correcting location information of a node in a wireless communication, according to an exemplary embodiment of the present invention; and

FIG. 7 illustrates a schematic diagram of a system for correcting location information of a node in a wireless communication, according to an exemplary embodiment of the present invention.

Like reference numerals refer to like parts throughout the several views of the drawings.

### DETAILED DESCRIPTION OF THE DRAWINGS

The exemplary embodiments described herein detail for illustrative purposes are subject to many variations and designs. It should be emphasized, however that the present invention is not limited to particular system and method of correcting and communicating location information of a node in a wireless communication environment as shown and described. Rather, the principles of the present invention can be used with a variety of location information correcting and communicating methods and techniques. It is understood that various omissions, substitutions of equivalents are contemplated as circumstances may suggest or render expedient, but the present invention is intended to cover the application or implementation without departing from the spirit or scope of the its claims.

In the following description, for purposes of explanation, numerous specific details are set forth in order to provide a thorough understanding of the present invention. It will be apparent, however, to one skilled in the art that the present invention may be practiced without these specific details.

As used herein, the term ‘plurality’ refers to the presence of more than one of the referenced item and the terms ‘a’, ‘an’, and ‘at least’ do not denote a limitation of quantity, but rather denote the presence of at least one of the referenced item.

The term ‘device’ also includes ‘engine’ or ‘machine’ or ‘system’ or ‘apparatus’. The term ‘node’ includes movable and non-movable/stationary objects, for example, vehicle, air plane, train, ship, buildings, etc. The vehicle includes truck, bus, trailer, car, bikes, or any other vehicle. The term localizer' includes a GPS antenna, a Geo-localization system antenna, a localization antenna. The term ‘communicator’ includes a communication antenna or any other communication means capable of communication data in a wireless network environment.

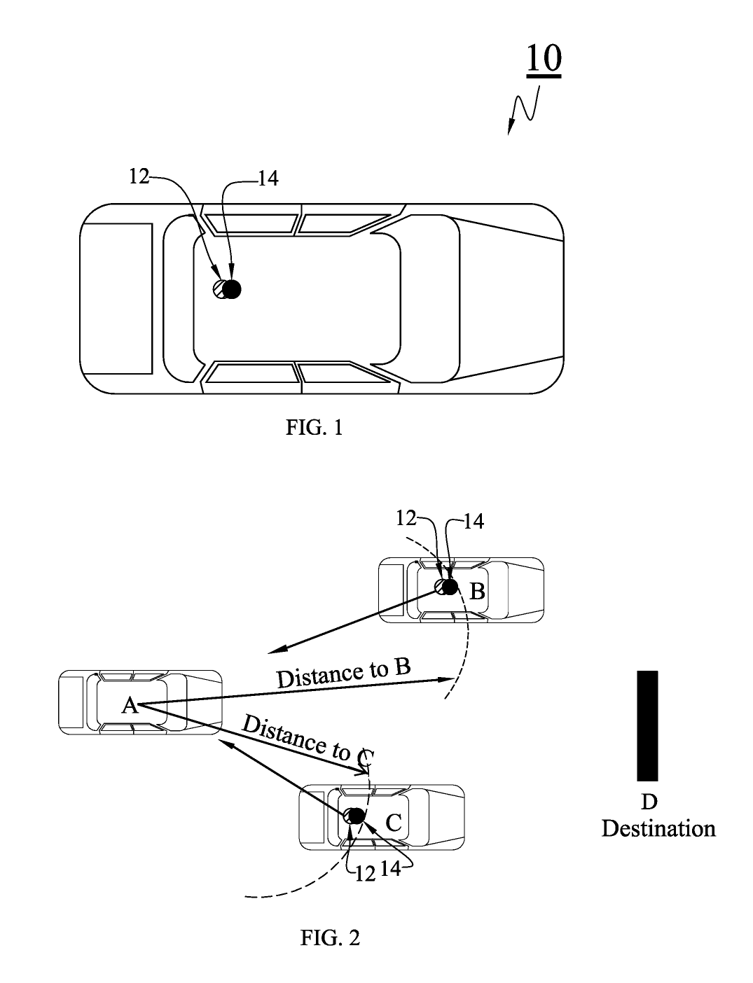

Referring to FIG. 1 wherein atleast a node 10, for example a vehicle that acts in a communication network has atleast a localizer 14 and atleast a communicator 12. The localizer 14 and the communicator 12 installed at the same place on the vehicle 10 such that when the communicator 12 transmits the location information of the vehicle 10 obtained by the localizer 14, the communicator 12 also transmits its own location along with it. The location information determined may be expressed in Latitude, Longitude and Azimuth coordinates.

Referring to FIG. 2 which illustrates a schematic diagram of vehicular communication when the communicator 12 and the localizer 14 are installed at same place on the vehicles B and C. As shown, the three vehicles, A, B and C are having their corresponding communicator 12 and the localizer 14 installed at same place on the vehicle B and C. In a vehicular communication, for example, if the vehicle A wants to send wirelessly some data to a communication unit/object to a destination D and if the destination D is out of communication range of the vehicle A, then the vehicle A may send its data to atleast one of the vehicle B and the vehicle C, that may forward its data to the destination D.

According to an exemplary embodiment of the present invention, different data forwarding mechanisms may be used, however, preferred method to forward data from one station to another station is to select the next forwarder which is the closest to the destination D. In this example, the vehicle B is closer to the destination D than the vehicle C and thus the vehicle B is selected by the vehicle A as the next forwarder.

To know the distance of the vehicle B and the vehicle C from the destination, the vehicle A needs to know the location of both the vehicle B and the vehicle C. For this each vehicle is enabled to periodically broadcast its current location information to the vehicle A as shown by the arrows pointing towards the vehicle A.

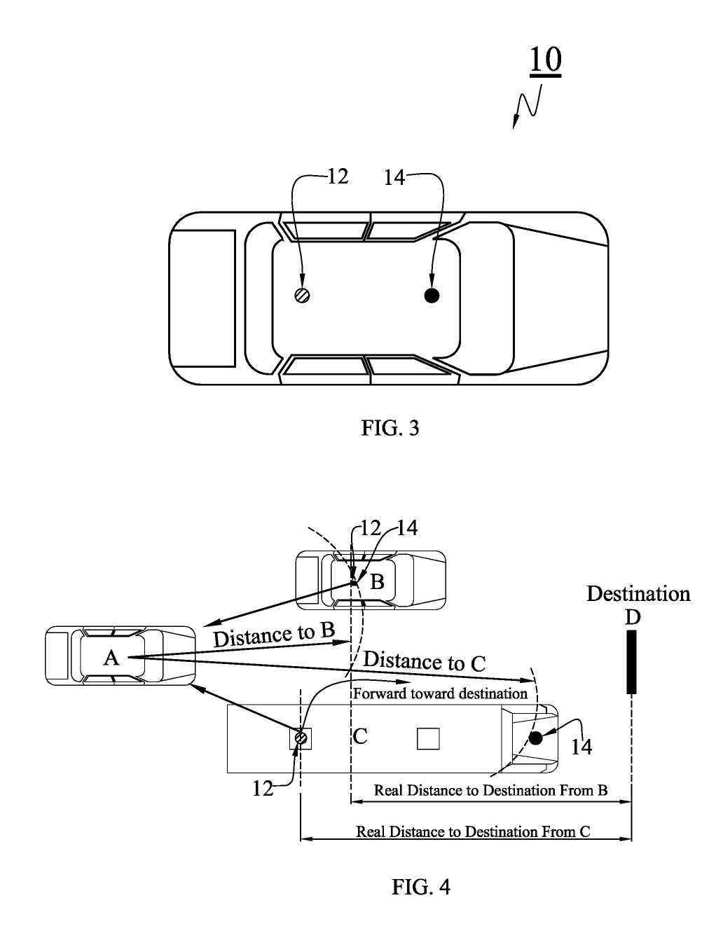

Referring to FIG. 3 that illustrates a vehicle 10 with the communicator 12 and localizer 14 installed at different places on the vehicle 10. The vehicle 10 has the communicator 12 and the localizer 14 installed at different places on the vehicle 10. So when the communicator 12 transmits the location information of the vehicle 10 obtained by the localizer 14, it actually transmits the location of the localizer.

Referring to FIG. 4 which illustrates a schematic diagram of vehicular communication when the communicator 12 and the localizer are installed at different places on one of the vehicles A, B and C, for example the vehicle C. The scheme is similar to the exemplary method described with the help of FIG. 2 above, except the vehicle C is replaced by a comparatively long vehicle where the communicator 12 and the localizer are installed at different locations on the vehicle C. The localizer is installed in the front portion of the vehicle C and the communicator 12 is installed in the back portion of the vehicle C.

When the vehicle C broadcasts its location information through wireless communication interface, it indicates the location of its localizer. Based on this, when selecting the next forwarder, the vehicle A sees that the vehicle C is closer to the destination D, and therefore, the vehicle A selects the vehicle C as the next forwarder according to conventional vehicular communication methods. However such conventional selection method is inefficient since the communicator 12 on vehicle C is not closer to destination when compared to communicator on the vehicle B, accordingly, selecting the vehicle C as the forwarder contradicts with the optimal forwarder selection procedure.

The forwarder is not the localizer, but it is the wireless communicator 12. It can be seen from the FIG. 4 that the vehicle C is closer to destination than the vehicle B, because the localizer of the vehicle C is located closer to destination than the localizer of the vehicle B. But, in reality, the communicator of the vehicle C is not closer to destination than the wireless antenna of the vehicle B. Therefore, according to an exemplary embodiment of the present invention, the vehicle A selects the vehicle B as next forwarder rather than the vehicle C.

It is important to note that a number of data routing protocols rely on the location of the communicator. For example, in case of greedy forwarding, the sender node selects the neighbour node which is closest to the destination node. If the localizer and the wireless communicators 12 are not installed at the same location on the node, for example, the vehicles B or C, the greedy forwarding may fail because the distance to the destination will be calculated from the location of the localizer and not from the location of the wireless communicator 12.

In the case of data forwarding, it is the wireless communicator 12 which forwards the data and not the localization localizer. Thus, knowing the location of the wireless communicator 12 is necessary to guarantee efficient data forwarding, and better communication systems. Therefore in the context of vehicular communication, it is important that a communicating node indicates the location of its wireless communicator 12 rather than the location of its localizer.

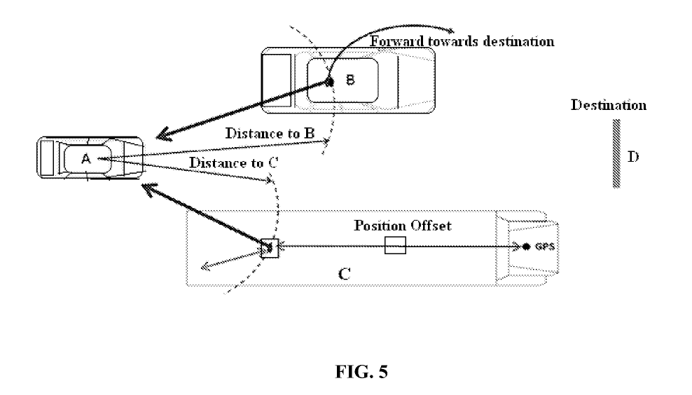

Referring to FIG. 5 which illustrates a schematic diagram of vehicular communication, according to an exemplary embodiment of the present invention. The present invention provides that when the vehicle C (also referred to as node ‘C’) broadcasts its location information, the vehicle C does not indicate the location of its localizer anymore, but it does indicate the location of its wireless communicator 12. The location of the wireless communicator 12 is calculated based on the location of the localizer by adding a position offset (relative position). The position offset is the displacement of the communicator 12 from the localizer. In the aforementioned example, it is preferable that each communicating vehicle A, B, and C calculates the location of its wireless communicator 12 based on the location it gets from the localizer. The calculated location could be expressed in Latitude, Longitude and Azimuth coordinates and it equals the Latitudes, Longitude and Azimuth as sensed by the GPS antenna plus Latitude, Longitude and Azimuth offsets respectively.

By doing so, whenever the vehicle A has data to send toward destination, it selects the vehicle B as next forwarder rather than the vehicle C. Considering the weak accuracy in GPS and other nowadays geo-localization systems, in case of small/personnel vehicles wherein the distance between the communicator 12 and the localizer is generally smaller, the present invention may also be applied. Further, the teachings of the present invention may also be applicable in the future when geo-localization systems reach high accuracy of few centimeters, for example, with GALILO system. With such high accurate localization, the few meters difference between the locations of the communicator 12 and the localizer may have a great impact on the efficiency of the communication system.

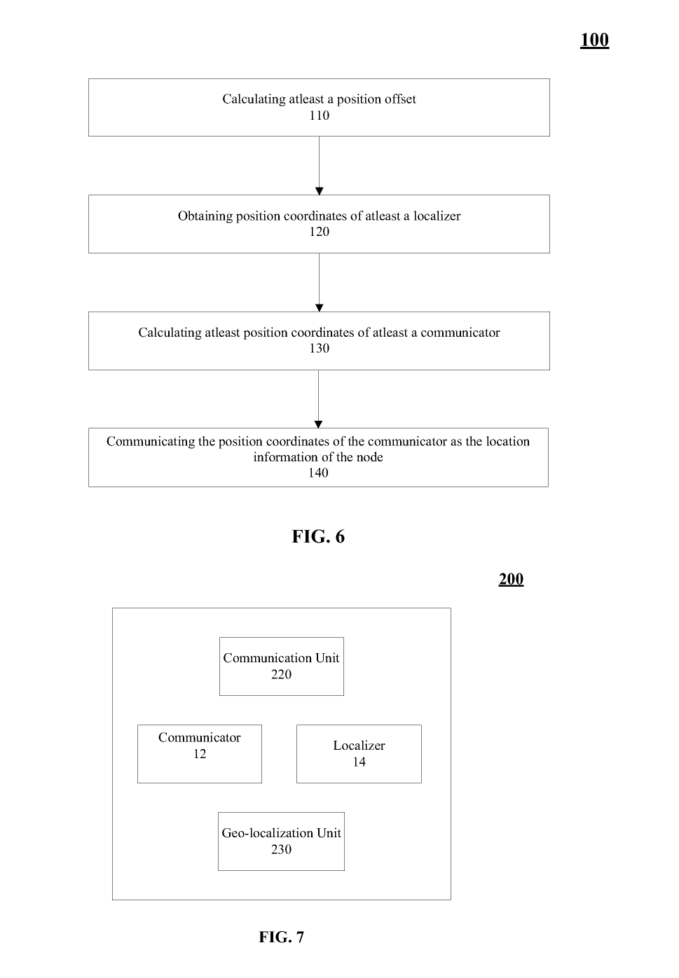

Referring to FIG. 6 which illustrates a flowchart of a method for correcting and communicating location information of a node such as a vehicle in a wireless communication network environment, according to an exemplary embodiment of the present invention. The method 100 starts with a step 110 of calculating atleast a position offset. The position offset is the distance between the communicator 12 and a localizer 14 on the node 10, for example, the vehicle A, B, or C. The distance between the wireless communicator 12 and the localizer 14 is manually or automatically calculated. It may also be known from the vehicle design and production steps.

At a next step 120, the position coordinates of the localizer 14 are obtained. In case the localizer 14 is a GPS antenna then GPS position coordinates is obtained. The GPS position coordinates may be indicated as latitude, longitude, azimuth coordinates or in a different position defining manner. The GPS position coordinates may be represented in the form of Latitude (LatGPS), Longitude (LonGPS) and Azimuth (AziGPS).

The latitude offset (LatOffset), the Longitude offset (LonOffset) and Azimuth offset (AziOffset) are calculated based on the distance provided by the step 110. LatOffset corresponds to the difference between the latitude of the GPS antenna as given by the step 120, and the latitude of the wireless communicator 12. LonOffset corresponds to the difference between the longitude of the localizer as given by the step 120, and the longitude of the wireless communicator 12. Similarly AziOffset corresponds to the difference between the azimuth of the localizer as given by the step 120, and the azimuth of the wireless communicator 12.

Next step 130 is of calculating the position coordinates of the communicator 12 using the position offset and the position coordinates of the localizer 14. The position coordinates of the communicator 12 may be represented by Latitude (LatNode), Longitude (LonNode) and Azimuth (AziNode) and is calculated as:

LatNode=LatGPS+LatOffset

LonNode=LonGPS+LonOffset

AziNode=AziGPS+AziOffset

At a step 140 the node or vehicle 10 communicates, the position coordinates of the communicator 12 as its location information. The position coordinates obtained in the step 130 i.e. LatNod, LonNode and AziNode are used to indicate the location information of the vehicle 10. The node 10 is capable of communicating atleast one of a location and an offset of atleast one of the localizer 14 and the communicator 12.

In another exemplary embodiment of the present invention a method of selecting forwarding node to transfer data from a node to a destination node in a communication network, is selected using the method 100. The position coordinates of the communicator 12 are used to decide which node is closer to the destination and a forwarder is chosen accordingly.

Referring to FIG. 7 which illustrates a schematic diagram of a system 200 for correcting location information of a mobile node in a wireless communication, according to an exemplary embodiment of the present invention. The system 200 comprises a localizer 14 (also referred to as ‘geo-localization antenna’) to obtain position coordinates. The localizer 14 capable of providing the GPS coordinates as the position coordinates indicated by latitude, longitude and azimuth. A communication unit 220 to enable the node 10 to communicate with other communicating units. The communicator 12 is capable of wirelessly transmitting data broadcasted by the communication unit 220. A Geo-localization unit 230 is adapted to calculate the position coordinates of the communicator 12 by adding a position offset to the position coordinates of the localizer 14. The position offset is a distance between the localizer 14 and the communicator 12.

It is important to note that the exemplary embodiments of the present invention described above, covers the application of the present invention in the field of data routing, however, the application of the present invention is also applicable in other potential fields of application such as location-based Medium Access Control (MAC) protocols and or any other communication protocol based on the location information of the communicating nodes.

In various exemplary embodiments of the present invention, the operations discussed herein, e.g., with reference to FIGS. 1 to 7, may be implemented through computing devices such as hardware, software, firmware, or combinations thereof, which may be provided as a computer program product, e.g., including a machine-readable or computer-readable medium having stored thereon instructions or software procedures used to program a computer to perform a process discussed herein. The machine-readable medium may include a storage device. For example, the operation of components of the method 100 and system 200 may be controlled by such machine-readable medium.

In other instances, well-known methods, procedures, components, and circuits have not been described herein so as not to obscure the particular embodiments of the present invention. Further, various aspects of embodiments of the present invention may be performed using various means, such as integrated semiconductor circuits, computer-readable instructions organized into one or more programs, or some combination of hardware and software.

Although a particular exemplary embodiment of the invention has been disclosed in detail for illustrative purposes, it will be recognized to those skilled in the art that variations or modifications of the disclosed invention, including the rearrangement in the configurations of the parts, changes in sizes and dimensions, variances in terms of shape may be possible. Accordingly, the invention is intended to embrace all such alternatives, modifications and variations as may fall within the spirit and scope of the present invention.

The foregoing descriptions of specific embodiments of the present invention have been presented for purposes of illustration and description. They are not intended to be exhaustive or to limit the invention to the precise forms disclosed, and obviously many modifications and variations in the configurations of the parts, changes in sizes and dimensions, variances in terms of shape may be possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A method for correcting and communicating location information of atleast a node in a wireless communication network environment, comprising the steps of:
calculating atleast a position offset;
obtaining position coordinates of atleast a localizer;
calculating atleast position coordinates of atleast a communicator; and
communicating the position coordinates of the communicator as the location information of the node.

2. The method according to claim 1, wherein the position offset is distance between the communicator and the localizer on the node.

3. The method according to claim 1, wherein the position offset is calculated according to design of the node.

4. The method according to claim 1, wherein the position coordinates represents location of the localizer.

5. The method according to claim 1, wherein the position coordinates is obtained by using the localizer.

6. The method according to claim 1, wherein the position coordinates of the communicator are calculated by using the position offset and the position coordinates of the localizer.

7. The method according to claim 1, wherein the node is capable of communicating atleast one of a location and an offset of atleast one of the Geo-localizer and the communicator.

8. The method according to claim 1, wherein the position coordinates of the communicator is calculated by adding the position offset to the position coordinates of the localizer.

9. The method according to claim 1, wherein the node includes atleast one of a movable object and a non-movable object.

10. The method according to claim 1, wherein the localizer includes atleast one of a GPS antenna, a Geo-localization system antenna, a localization antenna or any combination thereof.

11. A method of selecting atleast a forwarding node to transfer data from a node to a destination node in a wireless communication network, using the method of claim 1.

12. A system for correcting and communicating location information of atleast a node in a wireless communication network environment, comprising:
atleast a localizer capable of obtaining atleast position coordinates;
atleast a communication unit capable of enabling the node to communicate with other communicating units;
atleast a communicator capable of wireles sly transmitting atleast a data broadcasted by the communication unit; and
atleast a Geo-localization unit capable of calculating atleast the position coordinates of the communicator.

13. The system according to claim 12, wherein the position coordinates of the communicator is calculated by adding a position offset to the position coordinates of the localizer.

14. The system according to claim 12, wherein the position offset is a distance between the localizer and the communicator.

15. The system according to claim 12, wherein the localizer includes atleast one of a GPS antenna, a Geo-localization system antenna, a localization antenna or any combination thereof.

16. The system according to claim 12, wherein the communicator is capable of communication data of the node in a wireless network environment

17. A system for correcting location information of a mobile node in a wireless communication according to any of the previous claims.
